(19) United States
(12) Patent Application Publication
(10) Pub. No.: US 2007/0040666 A1
(43) Pub. Date: Feb. 22, 2007

(54) SYNCHRONIZED BRAKE LIGHTS

(76) Inventor: Peter J. Lenehan, Mission Viejo, CA (US)

Correspondence Address: SHELDON MAK ROSE & ANDERSON PC, 225 SOUTH LAKE AVENUE, 9TH FLOOR, PASADENA, CA, 91101, US

(21) Appl. No.: 11/465,565

(22) Filed: Aug. 18, 2006

Related U.S. Application Data
(60) Provisional application No. 60/709,909, filed on Aug. 19, 2005.
(60) Provisional application No. 60/723,213, filed on Oct. 3, 2005.

(51) Int. Cl. B60Q 1/44; G08G 1/00

(52) U.S. Cl. 340/479; 340/932

(57) ABSTRACT

Apparatus for synchronizing vehicle braking indicators to reduce braking reaction times of following vehicles includes a transmitter and signaler on each vehicle for producing rearwardly directed IR and visible radiation, respectively, in response to operation of vehicle brakes; and a forwardly oriented receiver for detecting a counterpart of the IR radiation. The apparatus substantially eliminates typical following divers' reaction times of one to two seconds per car, giving extra braking room of 100 to 200 feet per car at 70 MPH. The signaler can activate conventional brake lights of the vehicle and/or auxiliary brake lights, preferably for a limited signaling duration. The receiver can be responsive to a vehicle speedometer signal for operation only at or above a predetermined speed such as 10 MPH.

### CROSS REFERENCE TO RELATED APPLICATIONS

This application claims the benefit of Provisional Application Ser. Nos. 60/709,909 and 60/723,213, filed Aug. 19, 2005, and Oct. 3, 2005, respectively, and which are incorporated herein by this reference.

### BACKGROUND

The present invention relates to vehicle braking, and more particularly to vehicle brake lights.

Rear-end collisions on highways cause much death, injury and suffering, and results in billions of dollars lost by insurance companies paying claims for life insurance, hospitalization, and vehicle damage repair. It has been found in tests that the average reaction time or delay from brake light illumination to actual braking by a following vehicle is about one second (1.5 seconds according to National Highway Safety Administration (NHTSA) Paper 98-S2-P-31). At 70 MPH, a vehicle travels more than 100 feet in one second; if this distance can be saved in braking for each vehicle in a line, many rear-end collisions could be avoided. In a line of vehicles on a highway, each driver that reacts to the brake lights of the vehicle ahead causes a delay of about one second in braking. The vehicle at the end of the line will brake approximately X seconds after the first vehicle brakes, where X is the number of following vehicles in the line. This cumulative delay in braking is the main reason for rear-end collisions. The necessary distance between each vehicle in a line, for avoiding collisions in braking, is mainly a function of driver reaction delay, other braking parameters being equal. However, many drivers habitually follow much closer on congested freeways and highways.

Thus there is a need for a way to significantly reduce cumulative braking delays in lines of following vehicles.

### SUMMARY

The present invention meets this need by providing a system for synchronizing operation of braking indications of following vehicles, in the form of apparatus including a transmitter on one vehicle being responsive to operation of brakes of that vehicle for producing predetermined radiation rearwardly directed from that vehicle; a receiver means forwardly directed from another vehicle for detecting the predetermined radiation; and an illuminator for producing rearwardly directed illumination from the other vehicle in response to the receiver. The illuminator can be an activator of the brake lights of the other vehicle, which can be in the form of a solid state switch for driving the vehicle brake lights. Alternatively, the illuminator can include a rearwardly directed auxiliary brake light on the other vehicle. The apparatus also preferably is operative for limiting a duration of the rearwardly directed illumination for facilitating recognition of normal as opposed to synchronized braking indications, by a timed limitation of transmitter activation, or by a timed limitation of illuminator activation. In either alternative the timed limitation is preferably between approximately one second and approximately two seconds.

The transmitter preferably generates modulated radiation for facilitating discrimination of valid signals. The modulation is preferably at a frequency of at least approximately 1 KHz for limiting response time of the apparatus. Preferably the modulation is pulsed modulation having a duty cycle of not more than approximately 10 percent for high signal strength with low average transmission power. Preferably the duty cycle is not more than approximately 5 percent. The pulsed modulation preferably has a pulse width between approximately 20 microseconds and approximately 30 microseconds for enhanced detection range.

The receiver can include a detector circuit having a detector transducer, a pulse amplifier responsive to the detector transducer, the receiver being operative for determining a validly received signal based on an output frequency of the pulse amplifier. Preferably the detector circuit also includes a preamplifier having an inductor connected between its output and its inverting input for enhanced dynamic response. The validly received signal can be determined using a timer for producing a square wave at the modulation frequency when the pulse amplifier output is substantially at the modulation frequency, a filter for passing a receiver modulation signal when the timer is producing the square wave, and a rectifier for detecting the receiver modulation signal. Alternatively, the receiver can also include a microprocessor programmed for counting output pulses of the pulse amplifier during a predetermined period of time and comparing a resulting count with a predetermined valid count range. The predetermined period of time can be between approximately 10 milliseconds and approximately 100 milliseconds.

Preferably the radiation produced by the transmitter includes infra-red radiation for facilitating discrimination against visible radiation. Preferably the radiation is substantially confined within a horizontally disposed output angle of approximately 5 degrees for limiting interference to and from adjacent traffic lanes.

Preferably there are counterparts of the transmitter and the receiver in at least one vehicle.

In another aspect of the invention, apparatus in each of a plurality of vehicles includes a transmitter on the vehicle for producing a first predetermined radiation rearwardly directed from that vehicle in response to operation of the brakes of the vehicle; a signaler for producing a second and visible predetermined radiation rearwardly directed from the vehicle; a receiver forwardly directed from the vehicle for detecting a counterpart of the first predetermined radiation; the transmitter and the signaler being activated in response to the receiver. The signaler can activate conventional brake lights of the vehicle. Also, or in the alternative, the apparatus includes auxiliary brake lights, the signaling means activating of the auxiliary brake lights. Preferably the signaler is operative for a limited signaling duration, to maintain signaling only long enough for the brake pedal to be pressed.

### DRAWINGS

These and other features, aspects, and advantages of the present invention will become better understood with reference to the following description, appended claims, and accompanying drawings, where:

FIG. 1 is a system diagram of apparatus according to the present invention for synchronizing brake light activation of following vehicles, the apparatus being installed on one of a plurality of vehicles;

FIG. 2 is a side view of a line of vehicles equipped with the apparatus of FIG. 1;

FIG. 3 is a schematic block diagram of a transmitter portion of the apparatus of FIG. 1;

FIG. 4 is a block diagram of a receiver portion of the apparatus of FIG. 1;

FIG. 5 is a circuit diagram of a sensor and preamplifier portion of the receiver of FIG. 4;

FIG. 6 is a block diagram showing an alternative configuration of the receiver portion of FIG. 4;

FIG. 7 is a block diagram showing another alternative configuration of the receiver portion of FIG. 4;

FIG. 8 is a circuit diagram of the receiver portion of FIG. 8;

FIG. 9 is block diagram of a microprocessor-based implementation of the apparatus of FIG. 1; and

FIG. 10 is a flow chart of a brake light control process of the apparatus of FIG. 10.

### DESCRIPTION

The present invention is directed to apparatus for synchronizing brake light activation of following vehicles using a rear-facing directional transmitter that is powered upon vehicle brake light activation. A following vehicle would pick up a signal from the transmitter, immediately re-transmitting it to the next following vehicle, simultaneously initiating brake light operation of that vehicle, and so on, thereby eliminating the one-second reaction delay of each successively following driver. The transmitter-receiver range is preferably limited such as to 100 to 120 feet for eliminating interference from other vehicles.

While pulsed infra red (IR) radiation, described below, is preferred as the presently most practical and lowest cost directional tansmitter-receiver implementation, the present invention is not necessarily limited to any particular range of radiation frequency. IR LEDs pulsed at a standard rate provide good range and freedom from interference from other vehicles. The radiation is invisible, and penetrates fog and rain better than normal brake lights. An IR detector on the following vehicle simultaneously activates IR LEDs on that vehicle and its brake lights. This means that all these vehicle brake lights would turn on at the same time or synchronize with the brake lights of the first vehicle. The result is that all the vehicles behind the first vehicle would brake only about one second later, the cumulative delays that normally cause many of the worst rear-end collisions being eliminated. Drivers of vehicles not equipped with the invention would benefit by seeing brake lights a number of seconds earlier, depending on the number of equipped vehicles ahead.

Rather than pulse the IR LEDs continuously while the brake lights are on, the pulsed IR LEDs are preferably driven for one second, when the brake lights first come on, or when an IR signal from a leading vehicle is detected. This feature allows automatic turn-on of the brake lights of the following vehicle while limiting the possibility of reception by vehicles in other lanes, when many vehicles are so equipped. The IR LEDs typically have a narrow output angle of about 50 degrees, and typical IR detector diodes have an even narrower pickup angle. However, it is preferred that the detector diodes as well as the LEDs be shrouded for further decreasing the possibility of interference pickup from adjacent lanes.

The detector and associated receiver electronics can be mounted inside the passenger compartment near the center mirror, detecting through the windshield for long-term clarity, cleanliness, and reliability. The output from the detector triggers a two second timer to turn on the brake lights until the driver reacts to press the brake pedal. If the driver chooses not to brake, then only a short flash will be seen. In that case, a next-following driver is not likely to react with braking, although a heightened state of alertness is likely to result.

With reference to FIGS. 1-5 of the drawings, exemplary apparatus 10 of the present invention is installed on a vehicle 20, the vehicle having a brake pedal 22 or equivalent operatively connected to a brake actuator 24 for applying vehicle brakes 26, a brake light switch 28 activating a brake light 30 in a conventional manner upon and during application of the brakes. A rear-facing infrared (IR) transmitter 40 is connected to the brake lights, being activated in response to operation of the brake light switch 28, for producing rearwardly directed radiation from the vehicle 20 when its brakes are applied. An IR receiver 60 is oriented for detecting like radiation from another vehicle that the vehicle 20 is following, the receiver 60 also being connected to the brake light switch of the vehicle 20 for activating the brake light 30 independently of operation of the brake actuator 24.

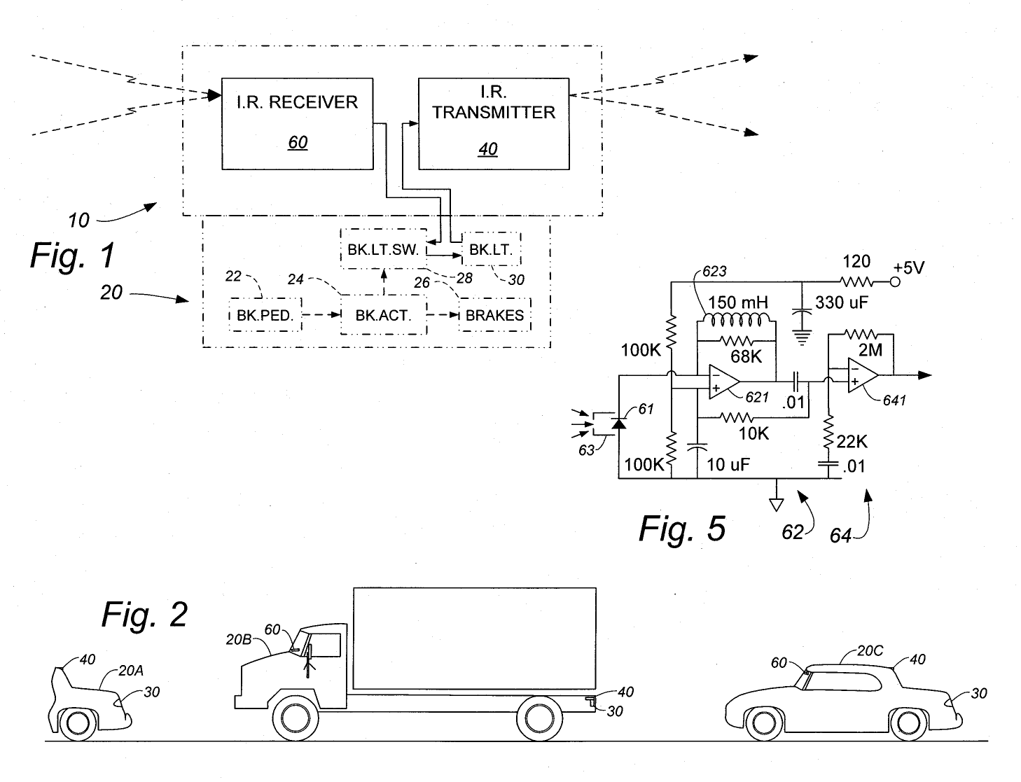

FIG. 2 shows three of the vehicles, designated 20A, 20B, and 20C, in a line, each of the vehicles 20 being equipped with counterparts of the apparatus 10. The vehicles 20A and 20C are typical passenger automobiles, and vehicle 20B is a van truck. The passenger vehicles 20A and 20C preferably have the IR receivers mounted behind the windshield, together with the rear-view mirror (that of vehicle 20C only being shown), whereas the truck 20B (being taller) has the receiver 60 mounted near the bottom of the windshield. The automobiles 20A and 20C preferably have the IR transmitters 40 mounted high, such as adjacent an upper stop light assembly, if present, whereas the truck 20B has the IR transmitter 40 mounted relatively lower such as together with the stop light 30 as shown in FIG. 2, a high mounting being typically much higher than the height of automobiles.

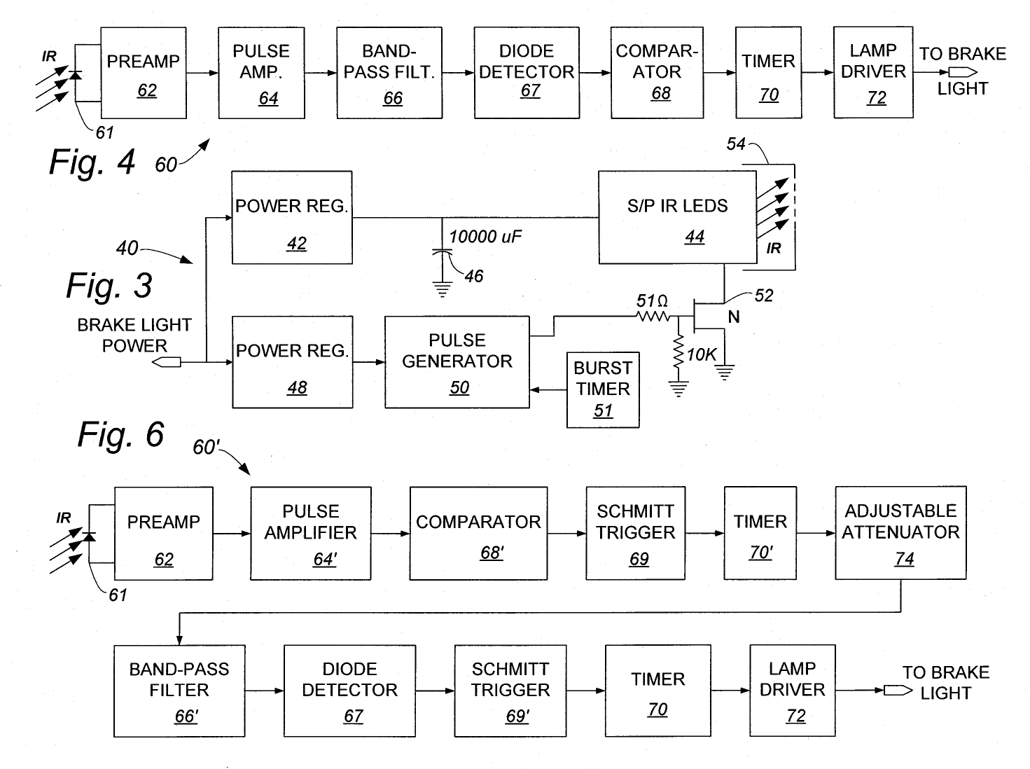

With particular reference to FIG. 3, the transmitter 40 includes a first power regulator 42 for powering a series-parallel IR LED emitter array 44, the regulator having a storage capacitor 46. A second power regulator 48 feeds a pulse generator 50 that is enabled by a burst timer 51 for driving a solid-state switch 52, periodically grounding the IR array at high repetition rate and low duty-cycle during an interval of approximately one second. Preferably the emitter array 44 is provided with a shroud 54 for avoiding transmission of radiation to adjacent lanes. The shroud 64 is configured for reducing the radiation angle of the array (or of the LEDs individually) to approximately five degrees.

Suitable devices for the switch 52 include power MOSFETs having low RDSon, one such commercially available device being IRLZ44N for switching up to 31 amps from 5 volt logic. A preferred pulse repetition rate is 1000 times per second, with a 10, 20, or 30 microsecond pulse width (corresponding to a duty cycle of one, two, or three percent), which allows a much higher pulse power output than is practical on a continuous basis. The longer pulse widths provide greater range and power, the modulation at the same time allowing the signal to be selectively detected, using a filter having a corresponding pass frequency (1 KHz in this case), thereby eliminating unwanted interference. This frequency (1 KHz in this example) would be the standard pulse repetition frequency, allowing every vehicle to be responsive to the braking transmissions of every other vehicle that is equipped with the present invention. This frequency also permits the receiver to achieve substantially instant brake light activation.

The first and second power regulators 42 and 48 are preferably powered from the brake light switch 28 for wiring simplicity, the first regulator 42 being current-limited such as to approximately 3 A for limiting inrush current to the storage capacitor 46, which is preferably of large value such as 10,000 μF, for high-current pulse drive of the emitter array 44 as described above. Once the capacitor is charged, the average current drawn at 12V is far less than the peak current powering the LEDs for only 10 microseconds. The first power regulator preferably is set for approximately 10V, with current limiting to approximately 3 A. The second regulator 48 can be a conventional voltage regulator, preferably set for 5V, a convenient operating voltage for the pulse generator 50 which can be a suitable 74-series integrated circuit, the regulator 48 having a relatively lower current rating such as 100 mA. Initial charging of the storage capacitor 46, with current limiting in the first power regulator 42 as described above, does result in a slight delay in achieving full power output of the IR LEDs 44; however, this delay is relatively negligible, on the order of 5 ms. The burst timer 51 is configured for disabling the pulse generator 50 after a suitable period such as one second, for decreasing the possibility of spurious reception by other vehicles equipped with the present invention that are in adjacent lanes. The burst timer 51 can be implemented conveniently in a known manner based on capacitive discharge or using a pulse counter.

FIG. 4 shows an exemplary configuration of the receiver 60, including an IR sensor 61 and an associated preamplifier 62 and pulse amplifier 64. More particularly, and as shown in FIG. 5, the IR sensor itself is preferably a PIN IR photodiode having a peak response at 890 nm. The preamplifier 62 includes an integrated operational amplifier 621 which is powered from a conventional 5-V regulator (not shown), and having a feedback inductor 623, the amplifier being configured for removing 60Hz pickup from streetlights, etc. It was discovered that the feedback inductor 623 materially improves rejection of ambient light interference. Preferably the IR sensor 61 is provided with a shroud 63 for excluding reception of radiation from adjacent lanes. The shroud 63 is configured for reducing the reception angle of the sensor to approximately five degrees.

The received signal from the sensor 61 and preamplifier 62, having a duration of approximately 10 μS as generated in the above-described exemplary configuration of the IR transmitter 40, is capacitively coupled to a counterpart of the operational amplifier, designated 641, of the pulse amplifier 64 as further shown in FIG. 5. A suitable integrated circuit for both operational amplifiers 621 and 641 is available as device MCP 6022 from a variety of sources. A suitable device for use as the IR sensor 61 is similarly available as PIN photodiode EL-PD333-2C/HO1.2.

The pulse amplifier 64 drives a (1 KHz) bandpass filter 66, preferably an active high-Q filter for discriminating against spurious radiation. The filter 66 thus “tunes” the receiver to signals having a pulse repetition rate of 1 KHz, thereby further eliminating interference. The resulting 1 KHz sine wave is fed through a rectifying diode detector 67 and compared with a reference voltage in a comparator 68 for producing a logic signal which feeds a timer 70 for activating a lamp driver 72, the output of which is connected to the brake light 30. The timer 70 has an active duration of approximately two seconds; consequently, the brake light is activated for that interval only, unless the interval is extended by operation of the vehicle brakes 26.

The apparatus 10 as described above has been tested, the results confirming an active range of approximately 75 feet. However, improved discrimination at the 1 KHz signal frequency was found to be desirable.

With further reference to FIG. 6, a preferred alternative configuration of the receiver, designated 60′, provides increased range and immunity from spurious signals. The receiver 60′ includes counterparts of the sensor 61, preamplifier 62, and of the pulse amplifier, designated 64′ (having increased high-frequency gain). The pulses, which are 10 μS in duration in the exemplary configuration of the IR transmitter 40 when a valid signal is being received, are directly fed to an inverted counterpart of the comparator, designated 68′, for passing pulses that exceed a predetermined amplitude greater than a noise amplitude. The comparator 68′ is connected to a Schmitt trigger 69, which triggers a counterpart of the timer, designated 70′ for producing corresponding pulses of uniform width being half the period of the pulse repetition rate of the IR transmitter 40, that is 500 μS in the preferred exemplary configuration described above. Thus, when radiation from the IR transmitter 40 of a leading vehicle is received, the output of the timer 71 is a 5V P-P square wave, at 1 KHz in this example. The output of the timer 70′ is fed through an adjustable attenuator 74 to a counterpart of the (high-Q) bandpass filter, designated 66′, producing an approximate sine wave output of robust amplitude only when fed at nearly exactly 1 KHz. This output of the filter 66′ is passed through a counterpart of the diode detector 67 to a counterpart of the Schmitt trigger, designated 69′, which activates a counterpart of the timer 70 that feeds a counterpart of the lamp driver 72 for activating the brake light 30 as described above.

The apparatus 10 including the IR receiver 60′ as described above has also been tested, the results confirming an extended active range of approximately 100 feet, and with improved discrimination and noise immunity.

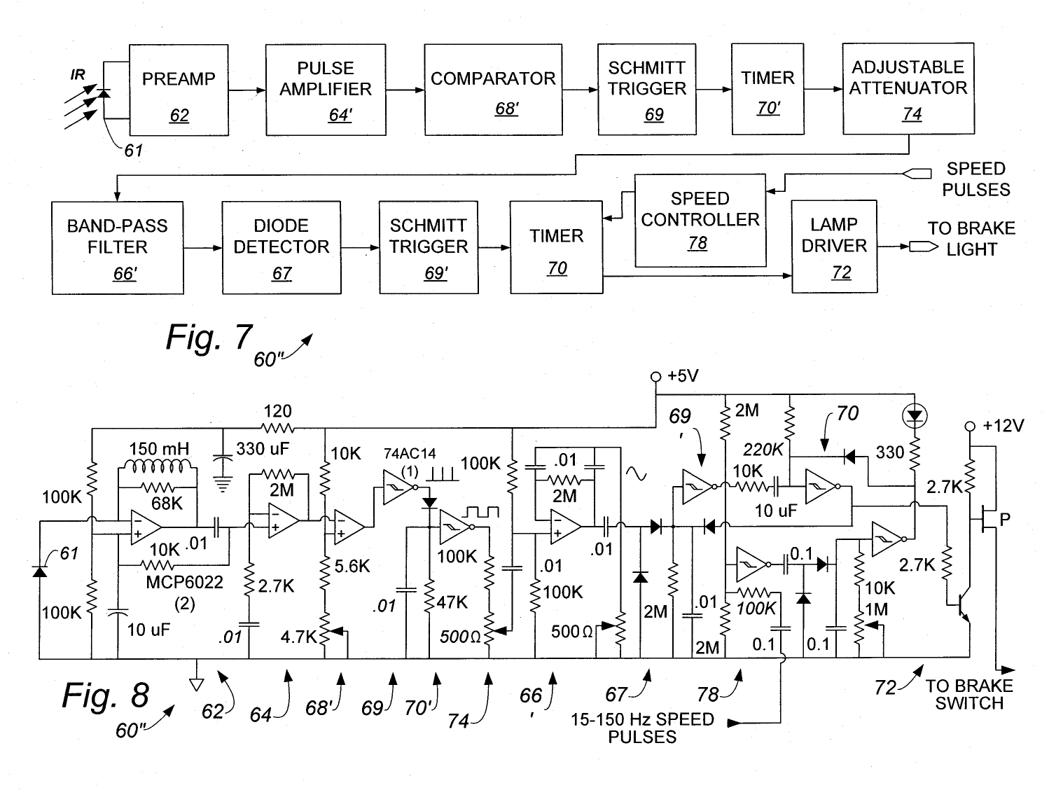

With further reference to FIGS. 7 and 8, another alternative configuration of the IR receiver, designated 60″, is responsive to vehicle speed for disabling operation below a predetermined speed such as 10 MPH. The receiver 60″ includes counterparts of the IR sensor 61, preamplifier 62, pulse amplifier 64′, comparator 68′, Schmitt trigger 69, and the timer 70′. The receiver 60″ also includes counterparts of the adjustable attenuator 74, band-pass filter 66′, diode detector 67, Schmitt trigger 69′, timer 70, and the lamp driver 72 as described above for the receiver 60′. The timer 70 is enabled by a speed controller 78 that receives a vehicle speed signal from the vehicle 20. Under modern practice (since 1985) typical vehicles no longer use traditional (Bowden) speedometer cables, the speed timer being configured for receiving speedometer pulses having a 10 MPH pulse rate of between 10 and 150 per second. Thus the receiver 60″ is operative for activating the brake light 30 for 2 seconds in response to validly received IR signals unless the vehicle is traveling at or under approximately 10 MPH.

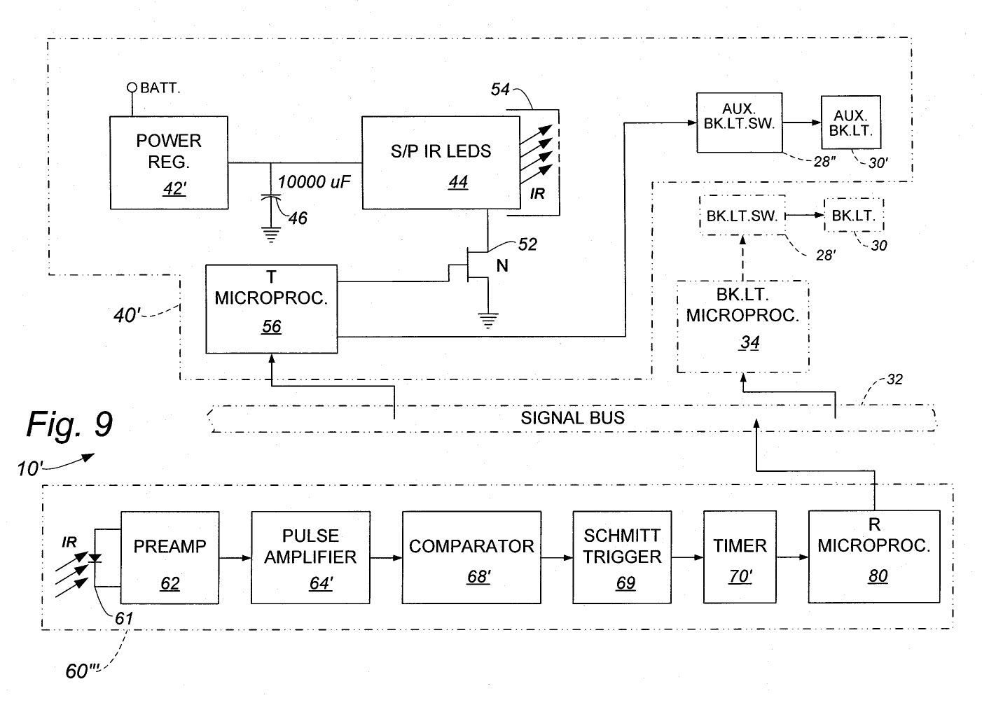

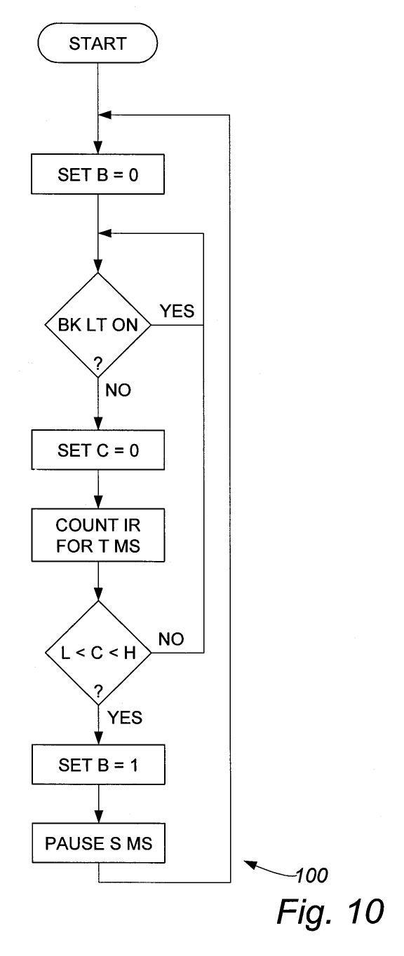

With further reference to FIGS. 9 and 10, an alternative configuration of the apparatus, designated 10′ has a microprocessor implementation, which is consistent with recent developments in vehicle technology. The vehicle 20, as is currently typical, includes one or more microprocessors (not shown) that communicate with vehicle components on a common signal bus 32 (such as a CANbus that is typically used in current vehicle manufacture), a counterpart of the brake light switch, designated 28′, being activated by a brake light microprocessor 34 in response to signals on the signal bus 32. The apparatus 10′ includes counterparts of the IR transmitter, designated 40′, and the IR receiver, designated 60′″, each being interfaced with the signal bus as described herein. The IR transmitter 40′ includes a transmit microprocessor 56 that is interfaced with the signal bus 52, being programmed for driving the solid state switch 52 directly or, if necessary through a suitable buffer (not shown). The microprocessor 56 monitors the signal bus 32 for activation signals addressed to the brake light microprocessor, programmed activation of the solid state switch 52 being a series of pulses (10 μS in duration with a repetition rate of 1 KHz and terminating after one second as described above in connection with the pulse generator 50, or other suitable combination), the pulses preferably terminating after one or two seconds as described above in connection with the burst timer 51.

A counterpart of the first power regulator, designated 42′, can be powered directly from a suitable switched battery bus, typically 12V, there being no particular advantage in powering from the vehicle brake light switch in this signal bus implementation of the apparatus 10′. Also, since the regulator 42′ commences charging the bypass capacitor 46 as soon as the battery bus is switched on, there is no associated delay in activation of the emitter array 44 from the time the solid state switch 52 is first activated by the transmit microprocessor 56.

Optionally, transmitter 40′ includes an auxiliary counterpart of the brake light switch, designated 28″, for driving an auxiliary counterpart of the brake light, designated 30′. The auxiliary brake light 30′ can be mounted together with the emitter array 44. As described below, the auxiliary brake light 30′ can be operated in unison with the vehicle brake light 30 as described above or, for example, only when the emitter array is activated, the vehicle brake light 30 being conventionally activated only in response to application of the brakes 26. Alternatively, the auxiliary brake light 30′ can be activated both during brake application and activation of the emitter array, the vehicle brake light activation also being restricted to brake application. In another alternative, further described below, the transmit microprocessor 56 can be programmed for addressing the brake light microprocessor 34 and activating the vehicle brake light 30 during activation of the emitter array 44, the brake light 30 also being conventionally activated during brake application. In this alternative the auxiliary brake light 30′ and associated auxiliary brake light switch 28″ can be omitted.

The IR receiver 60′″ includes counterparts of the IR sensor 61, the preamplifier 62, the pulse amplifier 64′, the comparator 68′, the Schmitt trigger 69, and the timer 70′, the timer 70′ feeding a receive microprocessor 80 that is interfaced with the signal bus 32. The microprocessor 80 is programmed for determining a validly received IR signal based on the pulse rate output of the Schmitt trigger 69, and addressing signals to the brake light microprocessor 34 for activating the brake light 30, the signals continuing for a limited duration such as two seconds as described above.

FIG. 10 shows a brake light control process 100 for operating the vehicle brake lights when an IR signal of proper frequency is picked up by the receiver 60′″. In the process 100, a brake output register B is initialized to zero (turning brake lights off, unless vehicle brakes are on). Optionally, for implementations activating the auxiliary brake light 30′, a check loop is entered (and reentered if the brake lights are already on). Next, a counter C is set to zero and then incremented by IR pulses during an interval of T milliseconds (100, for example). The resulting count is compared against low (L) and high (H) limits (95 and 105, for example) for validity. If valid, the register B is set for activating the brake lights and the process pauses for S milliseconds (2000, for example), after which control is returned to the beginning, resetting register B to zero to turn off the brake lights (unless the brakes are applied). The process 100 can be implemented in a microchip processor using a Basic compiler such as PicBasic Pro, available from Micro Engineering Labs, Inc., of Colorado Springs, Colo.

Using the preferred IR pulse repetition rate of 1 KHz with the count interval T being 100 mS, exemplary values for L and H, respectively, can be 96 and 94 (95<=C<=105), corresponding to a received pulse repetition rate range of 950 to 1050 Hz. In this example, the receive microprocessor 80 takes 100 mS to identify the received IR pulse frequency (thus giving a 100 mS reaction delay to each vehicle), whereas the bandpass filter 66′ requires less than 10 MS. Assuming the sample interval remains unchanged (1 mS), there is a trade-off between speed and accuracy. For example, using a count duration of 10 mS, one count corresponds to 10%, that is from 900 to 1100 Hz. It will be understood that other count intervals between 10 mS and 100 mS can provide corresponding trade-offs between speed and accuracy. In practice, however, much higher count rates are possible using current technology, and IR pulse rates higher than 1 KHz are contemplated within the scope of the present invention.

As described above, the transmit microprocessor 56 is operative for activating the emitter array 44 in response to brake light activation signals on the signal bus, regardless of their origination from the receive microprocessor 80 or the vehicle braking system. Alternatively, the receive microprocessor 80 can be implemented for addressing the transmit microprocessor exclusively, at least in configurations wherein the vehicle brake light is to be operated only in response to vehicle braking.

Although the present invention has been described in considerable detail with reference to certain preferred versions thereof, other versions are possible. For example, the enlargement structure 15 can be separately formed and bonded to the base portion 14. Also, a relay can be substituted for the solid state switch 52, although a delay on the order of 10 mS would be introduced. Therefore, the spirit and scope of the appended claims should not necessarily be limited to the description of the preferred versions contained herein.

What is claimed is:

1. Apparatus for synchronizing operation of braking indications of following vehicles, each vehicle having brakes and a brake light responsive to operation of the brakes, the apparatus comprising:
(a) transmitter means on one vehicle responsive to operation of the brakes of the one vehicle for producing predetermined radiation rearwardly directed from the one vehicle;
(b) receiver means forwardly directed from another vehicle for detecting the predetermined radiation; and
(c) means for producing rearwardly directed illumination from the other vehicle in response to the receiver means.

2. The apparatus of claim 1 wherein the means for producing comprises means for activating the brake lights of the other vehicle.

3. The apparatus of claim 2 wherein the means for activating comprises a solid state switch for driving the vehicle brake lights.

4. The apparatus of claim 1 wherein the means for producing comprises a rearwardly directed auxiliary brake light on the other vehicle.

5. The apparatus of claim 1, further comprising means for limiting a duration of the rearwardly directed illumination.

6. The apparatus of claim 5 wherein the means for limiting the duration of the rearwardly directed illumination comprises a timer for limiting an activation interval of the transmitter means.

7. The apparatus of claim 5 wherein the means for limiting the duration of the rearwardly directed illumination comprises a timer for limiting an activation interval of the means for producing.

8. The apparatus of claim 5 wherein the duration of the rearwardly directed illumination is limited to between approximately one second and approximately two seconds.

9. The apparatus of claim 1 wherein the transmitter means generates modulated radiation.

10. The apparatus of claim 9 wherein the modulation is at a frequency of at least approximately 1 KHz.

11. The apparatus of claim 9 wherein the modulation is pulsed modulation having a duty cycle of not more than approximately 10 percent.

12. The apparatus of claim 11 wherein the duty cycle is not more than approximately 5 percent.

13. The apparatus of claim 11 wherein the pulsed modulation has a pulse width between approximately 20 microseconds and approximately 30 microseconds.

14. The apparatus of claim 11 wherein the receiver means comprises a detector circuit having a detector transducer, a pulse amplifier responsive to the detector transducer, and means for determining a validly received signal based on an output frequency of the pulse amplifier.

15. The apparatus of claim 13, 14 wherein the detector circuit further comprises a preamplifier having an inductor connected between an output and an inverting input of the preamplifier.

16. The apparatus of claim 13, 14 wherein the means for determining comprises a timer for producing a square wave at the modulation frequency when the pulse amplifier output is substantially at the modulation frequency, a filter for passing a receiver modulation signal when the timer is producing the square wave, and a rectifier for detecting the receiver modulation signal.

17. The apparatus of claim 13, 14 wherein the means for determining comprises a microprocessor programmed for counting output pulses of the pulse amplifier during a predetermined period of time and comparing a resulting count with a predetermined valid count range.

18. The apparatus of claim 17 wherein the predetermined period of time is between approximately 10 milliseconds and approximately 100 milliseconds.

19. The apparatus of claim 13, 14 wherein the receiver is responsive to a speedometer signal of the vehicle, being activated only at or above a predetermined vehicle speed.

20. The apparatus of claim 19 wherein the predetermined vehicle speed is approximately 10 MPH.

21. The apparatus of claim 1 wherein the radiation comprises infra-red radiation.

22. The apparatus of claim 1 wherein the radiation is substantially confined within a horizontally disposed output angle of approximately 5 degrees.

23. The apparatus of claim 1, further comprising counterparts of the receiver means and the means for activating in the one vehicle.

24. Apparatus for synchronizing operation of brake lights of following vehicles, each vehicle having brakes and a brake light responsive to operation of the brakes, the apparatus comprising in each of a plurality of the vehicles:
(a) transmitter means on the vehicle for producing a first predetermined radiation rearwardly directed from that vehicle in response to operation of the brakes of the vehicle;
(b) signaling means for producing a second predetermined radiation rearwardly directed from the vehicle, the second predetermined radiation being visible illumination;
(c) receiver means forwardly directed from the vehicle for detecting a counterpart of the first predetermined radiation;
(d) means for activating the transmitter means in response to the receiver means; and
(e) means for activating the signaling means in response to the receiver means.

25. The apparatus of claim 24, wherein the signaling means comprises means for activation of the brake lights.

26. The apparatus of claim 24, further comprising auxiliary brake lights, wherein the signaling means comprises means for activation of the auxiliary brake lights.

27. The apparatus of claim 24, wherein the signaling means is operative for a limited signaling duration.
